(19) United States
(12) Patent Application Publication
(10) Pub. No.: US 2025/0262861 A1
(43) Pub. Date: Aug. 21, 2025

(54) WIPING DEVICE, LIQUID EJECTION DEVICE, AND METHOD FOR CONTROLLING A LIQUID EJECTION DEVICE

(71) Applicant: SEIKO EPSON CORPORATION, Tokyo (JP)

(72) Inventors: Toshio ARIMURA, SHIOJIRI-SHI (JP); Tomohiro NUMAJIRI, SHIOJIRI-SHI (JP); Ryoji FUJIMORI, SUWA-SHI (JP)

(21) Appl. No.: 19/057,435

(22) Filed: Feb. 19, 2025

(30) Foreign Application Priority Data
Feb. 21, 2024 (JP) 2024-024354

(51) Int. Cl. B41J 2/165

(52) U.S. Cl. CPC B41J 2/16544; B41J 2/1652; B41J 2002/1655; B41P 2235/242; B41P 2235/244; B41P 2235/246

(57) ABSTRACT

The wiping device includes a wiping device 30 configured to wipe a nozzle surface 25 of a liquid ejection head 22 which ejects a liquid, an absorbing member 39 configured to absorb liquid, and a movement mechanism that moves the absorbing member 39 to a contact position Pc configured to contact the nozzle surface 25 and a separated position separate from the nozzle surface 25, wherein the absorbing member 39 includes an impregnated section 56 configured to contact the nozzle surface 25 in a state in which the liquid is impregnated and a wiping section 55 configured to wipe the nozzle surface 25 by moving relative to the liquid ejection head 22.

The present application is based on, and claims priority from JP Application Serial Number 2024-024354, filed Feb. 21, 2024, the disclosure of which is hereby incorporated by reference herein in its entirety.

### BACKGROUND

### 1. Technical Field

The present disclosure relates to a wiping device, a liquid ejection device, and a control method of a liquid ejection device.

### 2. Related Art

For example, as in JP-A-2018-103399, there is a liquid ejecting device as an example of a liquid ejection device. The liquid ejecting device performs printing by ejecting ink, which is an example of a liquid, from a liquid ejecting head, which is an example of a liquid ejection head. The liquid ejecting device includes a wiper unit, which is an example of a wiping device. The wiper unit wipes the liquid ejection head by moving with the first roller and the second roller pressing a cloth sheet against the liquid ejection head.

Mist or the like scattered during ejection of liquid may cling to the liquid ejection head that performs printing by ejecting the liquid. When the liquid such as mist that clings to the liquid ejection head solidifies, it might not be wiped off by the cloth sheet.

### SUMMARY

To solve the above problem, a wiping device configured to wipe the nozzle surface of a liquid ejection head that ejects liquid includes a band-shaped absorbing member configured to absorb the liquid and a movement mechanism that moves the absorbing member to a contact position where the absorbing member is contactable with the nozzle surface and a separated position at which the absorbing member is separated from the nozzle surface, wherein the absorbing member includes an impregnated section configured to contact the nozzle surface in a state of being impregnated with liquid and a wiping section configured to wipe the nozzle surface by moving relative to the liquid ejection head.

To solve the above problem, a liquid ejection device includes a liquid ejection head that ejects a liquid from a nozzle formed in a nozzle surface and a wiping device with the above configuration.

To solve the above problem, a control method of a liquid ejection device, the liquid ejection device including a liquid ejection head that ejects a liquid from a nozzle formed in a nozzle surface and a wiping device configured to wipe the nozzle surface, wherein the wiping device includes a wiping section configured to wipe the nozzle surface by moving relative to the liquid ejection head, an absorbing member including an impregnated section configured to come into contact with the nozzle surface in a state of being impregnated with a liquid, and a movement mechanism that has a first movement mechanism configured to move the wiping section of the absorbing member to a position where the wiping section is contactable with the nozzle surface, and a second movement mechanism configured to move the impregnated section of the absorbing member to a position where the impregnated section contacts the nozzle surface, the control method including, using the second movement mechanism to bring the impregnated section into contact with the nozzle surface, and maintaining a state in which the impregnated section contacts the nozzle surface for a predetermined time, using the second movement mechanism to separate the impregnated section from the nozzle surface, using the first movement mechanism to move the wiping section to a position where the wiping section is contactable with the nozzle surface, and wiping the nozzle surface with the wiping section.

### BRIEF DESCRIPTION OF THE DRAWINGS

FIG. 1 is a schematic diagram of an embodiment of a liquid ejection device.

FIG. 2 is a perspective view of a wiping device.

FIG. 3 is a schematic cross-sectional view of the wiping device.

FIG. 4 is a perspective view of a pressing section and a support member.

FIG. 5 is a schematic cross-sectional view of the wiping device in which the wiping section is positioned at a wiping position.

FIG. 6 is a schematic cross-sectional view of the wiping device in which an impregnated section is positioned at an impregnation position.

FIG. 7 is a schematic cross-sectional view of the wiping device in which the impregnated section is positioned at a contact position.

### DESCRIPTION OF EMBODIMENTS

### Embodiments

Hereinafter, an embodiment of a wiping device, a liquid ejection device, and a control method of the liquid ejection device will be described with reference to the drawings. The liquid ejection device is an inkjet printer for printing images such as characters and photographs by ejecting ink, which is an example of a liquid, onto a medium such as paper or cloth.

In the drawings, a liquid ejection device 11 is placed on a horizontal surface, the direction of gravity is indicated by the Z-axis, and the directions along the horizontal surface are indicated by the X-axis and the Y-axis. The X-axis, the Y-axis, and the Z-axis are orthogonal to each other. In the following description, the directions parallel to the X-axis is referred to as scanning direction X1 and wiping direction X2, a direction parallel to the Y-axis is referred to as width direction Y, and a direction parallel to the Z-axis is referred to as vertical direction Z. The wiping direction X2 is a direction opposite to the scanning direction X1.

### Liquid Ejection Device

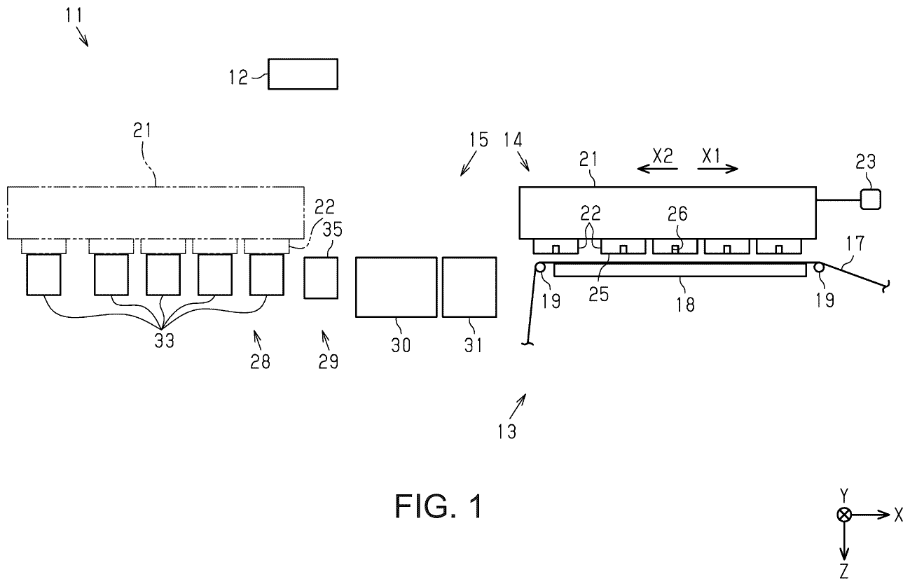

As shown in FIG. 1, the liquid ejection device 11 may include a control section 12, a medium transport section 13, a printing section 14, and a maintenance section 15.

The control section 12 integrally controls the driving of each mechanism in the liquid ejection device 11, and controls various operations executed in the liquid ejection device 11.

The control unit 12 can be configured as a circuit including a: one or more processors that execute various processes according to a computer program, β: one or more dedicated hardware circuits that execute at least a part of the various processes, or y: a combination thereof. The hardware circuit is, for example, an application-specific integrated circuit. The processor includes a CPU and memory, such as RAM and ROM, and the memory stores program code or instructions configured to cause the CPU to perform processes. Memory or computer-readable medium includes any readable medium that can be accessed by a general purpose or special purpose computer.

### Medium Transport Section

The medium transport section 13 is configured to transport medium 17. The medium transport section 13 may include a medium support section 18 and a transport roller 19.

The medium support section 18 supports the medium 17. The medium support section 18, for example, supports the medium 17 from below. The medium support section 18 supports the medium 17 to be transported.

The medium transport section 13 may include a plurality of transport rollers 19. The transport roller 19 transports the medium 17 by rotating.

The medium transport section 13, for example, transports the medium 17 intermittently. Specifically, the medium transport section 13 stops transporting the medium 17 while the printing section 14 performs printing on the medium 17. The medium transport section 13 transports the medium 17 after printing is performed on the medium 17. The medium transport section 13 may transport not only an elongated medium 17 but also a single-sheet medium 17.

### Printing Section

The printing section 14 is configured to perform printing on the medium 17. The printing section 14 performs printing on a region of the medium 17 that is supported by the medium support section 18. The printing section 14 may include a carriage 21, a liquid ejection head 22, and a pressurizing section 23.

The carriage 21 is configured to reciprocate in the scanning direction X1 and the wiping direction X2. The carriage 21 passes through a position facing the medium 17 by reciprocating in the scanning direction X1 and the wiping direction X2. The carriage 21, for example, passes over the medium support section 18.

In the liquid ejection device 11 of the present embodiment, the direction in which the carriage 21 moves coincides with the direction in which the medium 17 moves over the medium support section 18. Therefore, the liquid ejection device 11 is a lateral printer. The liquid ejection device 11 may be a serial printer in which the medium 17 is transported in a direction different from the scanning direction X1.

The printing section 14 may include a plurality of liquid ejection heads 22. The printing section 14 of the present embodiment includes five liquid ejection heads 22. The plurality of liquid ejection heads 22 may be provided side by side in the scanning direction X1. The plurality of liquid ejection heads 22 each have a same configuration. Therefore, a single liquid ejection head 22 will be described below.

The liquid ejection head 22 is configured to eject liquid. The liquid ejection head 22 of the present embodiment ejects liquid in the vertical direction Z. The liquid ejection head 22 has a nozzle surface 25. A nozzle 26 is formed on the nozzle surface 25. The nozzle surface 25 is a surface on which one or more nozzles 26 are opened. The liquid ejection head 22 ejects liquid from the nozzle 26. The liquid ejection head 22 is mounted on the carriage 21. The liquid ejection head 22 prints an image on the medium 17 by ejecting liquid onto the medium 17. The plurality of liquid ejection head 22 may eject the same type of liquid or different types of liquid. For example, four liquid ejection heads 22 may eject ink of different colors, and a single liquid ejection head 22 may eject a reaction liquid that aggregates the ink.

The liquid ejection head 22 is, for example, a line head configured to simultaneously eject liquid onto the medium 17 across the width direction Y. The liquid ejection head 22 is movable in the scanning direction X1. The liquid ejection head 22 is movable in the wiping direction X2. The liquid ejection head 22 reciprocates in the scanning direction X1 and the wiping direction X2 together with the carriage 21. The liquid ejection head 22 can eject liquid over the entire area of the medium 17 supported by the medium support section 18.

The pressurizing section 23 is connected to the liquid ejection head 22. The pressurizing section 23, for example, pressurizes the inside of the plurality of liquid ejection heads 22. The printing section 14 may include a plurality of pressurizing sections 23. For example, the printing section 14 may include a pressurizing section 23 for each of the liquid ejection heads 22.

The pressurizing section 23 is, for example, a pump. The pressurizing section 23 pressurizes the inside of the liquid ejection head 22 to discharge liquid from the liquid ejection head 22. That is, the pressurizing section 23 pressurizes the inside of the liquid ejection head 22, thereby pressurizing and discharging the liquid from the nozzle 26. Discharging the liquid under pressure is also called pressure cleaning. Pressure cleaning is maintenance that involves forcibly discharging liquid from the nozzle 26 to discharge air bubbles, foreign matter, and the like from the nozzle 26, together with the liquid in the liquid ejection head 22.

### Maintenance Section

The maintenance section 15 is configured to maintain the liquid ejection head 22. The maintenance section 15 may include a moisturizing section 28, a cleaning section 29, a wiping device 30, and a liquid receiving section 31. The moisturizing section 28, the cleaning section 29, the wiping device 30, the liquid receiving section 31, and the medium support section 18 may be provided side by side in this order in the scanning direction X1. That is, in the scanning direction X1, the liquid receiving section 31 may be disposed adjacent to the wiping device 30 in the scanning direction X1.

The moisturizing section 28 may include one or more moisturizing caps 33. The moisturizing section 28 may be provided with the same number of moisturizing caps 33 as the number of liquid ejection heads 22. The moisturizing cap 33 forms a space communicating with the nozzle 26 by contacting the liquid ejection head 22. The moisturizing cap 33 caps the liquid ejection head 22 located at a home position indicated by two-dot chain line in FIG. 1. The moisturizing cap 33 moisturizes the nozzle 26 by capping the liquid ejection head 22.

The cleaning section 29 performs suction cleaning of the liquid ejection head 22 by sucking the liquid from the liquid ejection head 22. The cleaning section 29 may include one or more suction caps 35. The cleaning section 29 may clean each of the liquid ejection heads 22 individually. The cleaning section 29 may clean multiple liquid ejection heads 22 simultaneously.

The suction cap 35 is in contact with the liquid ejection head 22, thereby forming a space that communicates with the nozzle 26. The suction cap 35 caps the liquid ejection head 22. The cleaning section 29 performs suction cleaning by sucking the inside of the suction cap 35 to create a negative pressure. By performing suction cleaning on a liquid ejection head 22 that is not filled with liquid, the liquid ejection head 22 can be filled with liquid. By performing suction cleaning on the liquid ejection head 22 filled with liquid, air bubbles, foreign matter, and the like in the liquid ejection head 22 can be discharged. The suction cap 35 receives the liquid discharged during suction cleaning.

The liquid receiving section 31 is configured to receive liquid discharged from nozzle 26. The liquid receiving section 31 may receive the liquid discharged from the liquid ejection head 22 by the pressurizing section 23. That is, the liquid receiving section 31 may receive the liquid discharged during pressure cleaning. The liquid receiving section 31 may receive idly ejected liquid. The idle ejection is an operation of ejecting liquid from the nozzle 26 in order to suppress clogging of the nozzle 26. Idle ejection is also called flushing. By idle ejection, for example, thickened liquid is discharged from nozzle 26. The liquid receiving section 31 receives the liquid discharged from the liquid ejection head 22 facing the liquid receiving section 31.

### Wiping Device

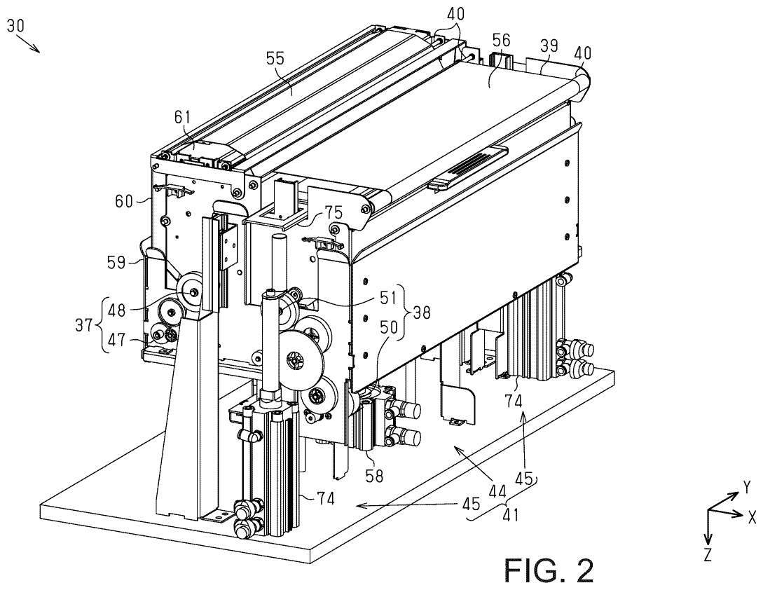

As shown in FIG. 2, the wiping device 30 may include a feed out section 37, a winding section 38, an absorbing member 39, a guide roller 40, and a movement mechanism 41. The wiping device 30 may include a plurality of guide rollers 40. The movement mechanism 41 may include a first movement mechanism 44 and a second movement mechanism 45.

The feed out section 37 may include a braking section 47 and a feed out shaft 48. The braking section 47 restricts rotation of the feed out shaft 48. The braking section 47 applies a load to the rotating feed out shaft 48. The feed out shaft 48 supports an unused absorbing member 39 wound in a roll shape. The feed out shaft 48 rotates to feed the unused absorbing member 39.

The winding section 38 can wind up the absorbing member 39. The winding section 38 may include a drive source 50 and a winding shaft 51. The drive source 50 rotates the winding shaft 51. The winding shaft 51 winds up and supports the used absorbing member 39 in a roll shape.

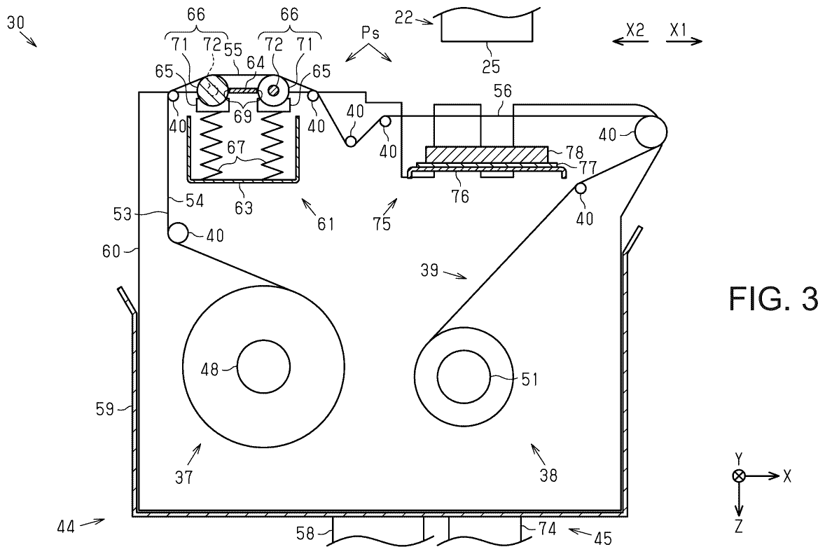

As shown in FIG. 3, the absorbing member 39 is strip-shaped. The absorbing member 39 is wound around a plurality of guide rollers 40. The plurality of guide rollers 40 extend, for example, in the width direction Y. The absorbing member 39 fed from the feed out section 37 is sent to the winding section 38 via a plurality of guide rollers 40.

The absorbing member 39 can absorb liquid. The absorbing member 39 is, for example, cloth. The absorbing member 39 has a contact surface 53 and a back surface 54. The contact surface 53 is a surface that contacts the nozzle surface 25. The back surface 54 is a surface opposite to the contact surface 53. The absorbing member 39 has a wiping section 55 and an impregnated section 56. The wiping section 55 may be positioned ahead of the impregnated section 56 in the wiping direction X2. The wiping section 55 may be disposed between the cleaning section 29 and the impregnated section 56 in the scanning direction X1.

As shown in FIG. 3, when the absorbing member 39 is positioned at the separated position Ps, the wiping section 55 and the impregnated section 56 are positioned below the nozzle surface 25. The separated position Ps is a position where the absorbing member 39 is separated from the nozzle surface 25. The wiping section 55 and the impregnated section 56 located at the separated position Ps do not interfere with the liquid ejection head 22 that reciprocates in the scanning direction X1.

The first movement mechanism 44 may include a first lifting section 58, a holder 59, a frame 60, and a pressing section 61.

The holder 59 detachably attached to hold the frame 60. The frame 60 rotatably supports the feed out shaft 48 and the winding shaft 51. The user can replace the absorbing member 39 by removing the frame 60 from the holder 59 and removing the feed out shaft 48 and the winding shaft 51 from the frame 60.

The first lifting section 58 is, for example, an air cylinder. The first lifting section 58 reciprocates the holder 59 in the vertical direction Z. The first lifting section 58 moves the holder 59 and the frame 60 supported by the holder 59. That is, the first movement mechanism 44 reciprocates the entire absorbing member 39 in the vertical direction Z.

The pressing section 61 is configured to press the wiping section 55 against the nozzle surface 25. The absorbing member 39 winds around the pressing section 61. The pressing section 61 includes a holding member 63, a cover member 64, a mounting member 65, a roller 66, and an elastic member 67. The pressing section 61 may include a plurality of mounting members 65, rollers 66, and elastic members 67. The holding member 63 and the cover member 64 form a space for accommodating the mounting member 65, the roller 66, and the elastic member 67.

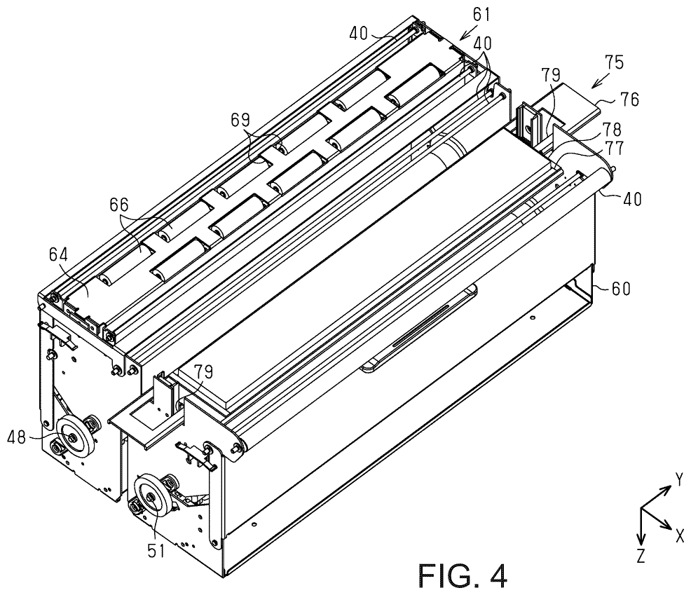

As shown in FIGS. 3 and 4, the cover member 64 has the same number of through holes 69 as the number of rollers 66. A part of the roller 66 protrudes from the corresponding through hole 69.

As shown in FIG. 3, the roller 66 is mounted on the mounting member 65. The roller 66 contacts the back surface 54 of the absorbing member 39. The mounting member 65 rotatably holds the roller 66. The roller 66 may be driven to rotate by the transported absorbing member 39. The elastic member 67 pushes the mounting member 65. The elastic member 67 pushes up the absorbing member 39 via the mounting member 65 and the roller 66. The elastic member 67 is, for example, a spring.

The roller 66 has a cylindrical section 71 and a shaft section 72. The cylindrical section 71 is a section around which the absorbing member 39 winds. The shaft section 72 is a portion to be inserted into the cylindrical section 71. The shaft section 72 is mounted to the mounting member 65. The shaft section 72 extends, for example, in the width direction Y. In the roller 66, the cylindrical section 71 in contact with the wiping section 55 may have elasticity. The cylindrical section 71 may be formed of, for example, a member such as sponge or rubber. In this case, the absorbing member 39 more intimately contacts the nozzle surface 25.

A plurality of shaft sections 72 are attached to different mounting members 65. Therefore, the plurality of shaft sections 72 can be inclined at different angles. Therefore, the plurality of cylindrical sections 71 can be inclined in accordance with the nozzle surface 25 when wiping the nozzle surface 25. By this, the absorbing member 39 easily comes into intimate contact with the nozzle surface 25.

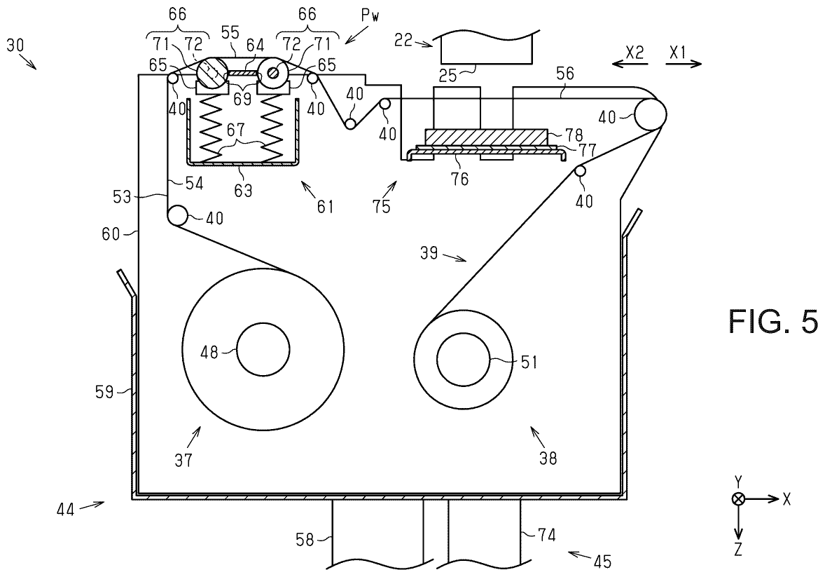

As shown in FIG. 5, the first movement mechanism 44 can move the absorbing member 39 to the wiping position Pw. The first movement mechanism 44 moves the wiping section 55 to the separated position Ps shown in FIG. 3 and to the wiping position Pw shown in FIG. 5. When the absorbing member 39 is located at the wiping position Pw, the wiping section 55 is located above the nozzle surface 25. The wiping position Pw is a position at which the wiping section 55 can come into contact with the nozzle surface 25. When the absorbing member 39 is located at the wiping position Pw, the impregnated section 56 is located below the nozzle surface 25. The wiping position Pw is a position at which the impregnated section 56 is separated from the nozzle surface 25. The wiping section 55 positioned at the wiping position Pw interferes with the liquid ejection head 22 reciprocating in the scanning direction X1.

The wiping device 30 is configured to wipe the nozzle surface 25. The wiping section 55 is configured to wipe the nozzle surface 25 by moving relative to the liquid ejection head 22. In the embodiment, wiping of the nozzle surface 25 is performed by moving the liquid ejection head 22 in the wiping direction X2 with respect to the wiping section 55, which is stopped at the wiping position Pw. The wiping section 55 removes the liquid clinging to the nozzle surface 25. The wiping device 30 wiping the nozzle surface 25 is also called wiping.

As shown in FIG. 2, the movement mechanism 41 may include a plurality of second movement mechanisms 45. The movement mechanism 41 of the present embodiment includes a pair of second movement mechanisms 45. The pair of second movement mechanisms 45 are provided on both sides of the holder 59 at intervals in the width direction Y.

The second movement mechanism 45 may include a second lifting section 74 and a support member 75.

The second lifting section 74 is, for example, an air cylinder. The second lifting section 74 pushes the support member 75 from below. The second lifting section 74 reciprocates the support member 75 in the vertical direction Z. The second movement mechanism 45 can move the support member 75.

As shown in FIG. 4, the support member 75 may include a support plate 76, an elastic body 77, and a porous body 78.

The support plate 76 may have one or more guide sections 79. The guide section 79 is, for example, a surface corresponding to the frame 60. The guide section 79 of the present embodiment is an inner surface of a hole penetrating the support plate 76. The guide section 79 guides the support plate 76 in the vertical direction Z. The guide section 79 allows the support plate 76 to move in the vertical direction Z and the direction opposite to the vertical direction Z, but restricts the support plate 76 from moving in the scanning direction X1 and the width direction Y. The support member 75 is provided so as to be capable of reciprocating in the vertical direction Z.

The elastic body 77 and the porous body 78 may be plate-shaped members. The elastic body 77 and the porous body 78 may be provided so as to be stacked on the support plate 76. The elastic body 77 may be placed on the support plate 76. The porous body 78 may be placed on the elastic body 77. The porous body 78 is, for example, a sponge or a sea sponge. The porous body 78 may be elastic. The porous body 78 may have water absorption or moisture absorption properties. The elastic body 77 has elasticity. The elastic body 77 is, for example, rubber, a spring, or the like.

As shown in FIG. 3, the support member 75 is positioned below the impregnated section 56. The support member 75 may be on standby at a position separated from the absorbing member 39 positioned at the separated position Ps. The porous body 78 may face the back surface 54 of the impregnated section 56. The support member 75 located at the standby position shown in FIG. 3 comes into contact with the back surface 54 of the impregnated section 56 by moving upward. The second movement mechanism 45 is movable between a position at which the support member 75 is brought into contact with the impregnated section 56 and a position at which the support member 75 is separated from the impregnated section 56. The support member 75 is movable so as to push up the impregnated section 56. The support member 75 may pull out the absorbing member 39 from the feed out section 37 when pushing up the impregnated section 56.

In the support member 75, the portion in contact with the impregnated section 56 may be larger than the nozzle surface 25 in the scanning direction X1. In the support member 75, the portion in contact with the impregnated section 56 may be larger than the nozzle surface 25 in the width direction Y. In the present embodiment, the porous body 78 is in contact with the impregnated section 56. In the present embodiment, the impregnated section 56 is larger than the nozzle surface 25 in both the scanning direction X1 and the width direction Y.

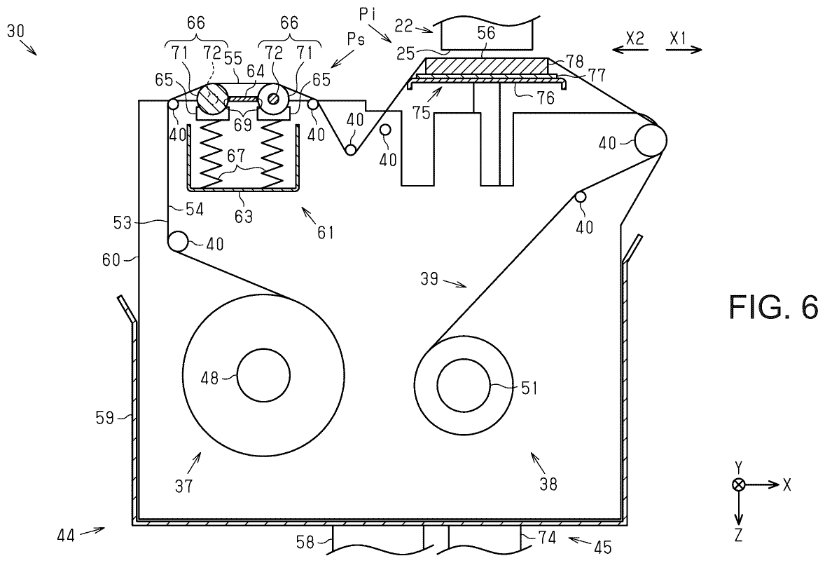

As shown in FIG. 6, the second movement mechanism 45 can move the impregnated section 56 to the impregnation position Pi. The impregnation position Pi is a position that is closer to the nozzle surface 25 than the separated position Ps and where the impregnated section 56 does not come into contact with the nozzle surface 25. When the second movement mechanism 45 moves the impregnated section 56, the wiping section 55 does not move. Therefore, at this time, the wiping section 55 is positioned below the nozzle surface 25. The absorbing member 39 in a state in which the impregnated section 56 is positioned at the impregnation position Pi does not interfere with the liquid ejection head 22.

The liquid ejection head 22 may eject the liquid from the nozzle 26 toward the impregnated section 56 located at the impregnation position Pi. The liquid ejection head 22 may impregnate the impregnated section 56 with the ejected liquid. Impregnation is the permeation of liquid into gaps such as fine holes. That is, the impregnated section 56 can absorb the liquid supplied to the contact surface 53, bring it inside, and hold the absorbed liquid. The liquid ejection head 22 for supplying the liquid to the impregnated section 56 may be one or plural.

A single liquid ejection head 22 may eject the liquid while being stopped at a position facing the impregnated section 56, for example. For example, a single liquid ejection head 22 may eject the liquid while reciprocating in the scanning direction X1 above the impregnated section 56. For example, one or more liquid ejection heads 22 may supply the liquid to the impregnated section 56 at a timing when the liquid ejection heads 22 pass above the impregnated section 56 while moving in the scanning direction X1 or the wiping direction X2.

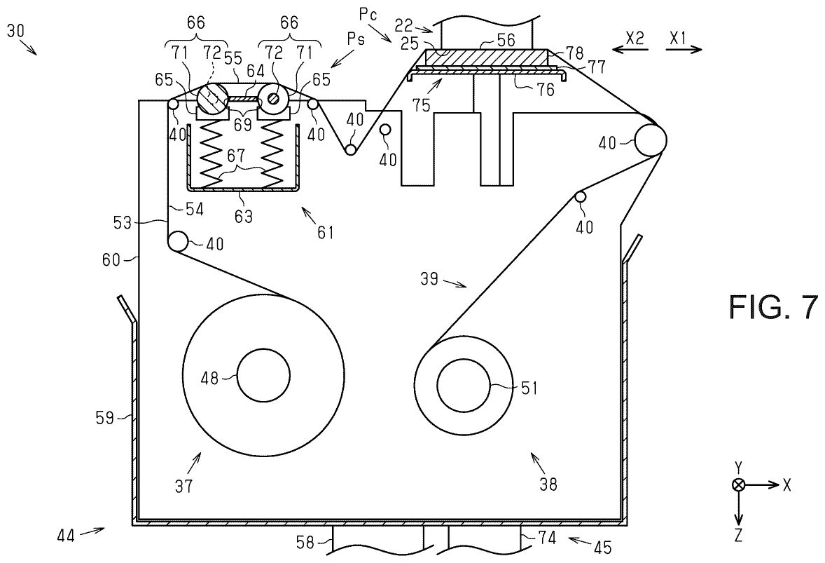

As shown in FIG. 7, the second movement mechanism 45 can move the impregnated section 56 of the absorbing member 39 to the contact position Pc where the impregnated section 56 contacts the nozzle surface 25. The second movement mechanism 45 can move the impregnated section 56 to the contact position Pc. The contact position Pc is a position closer to the nozzle surface 25 than the impregnation position Pi. The contact position Pc is a position where the impregnated section 56 contacts the nozzle surface 25. The impregnated section 56 can come into contact with the nozzle surface 25 in a state of being impregnated with the liquid. The contact position Pc is a position at which the absorbing member 39 can contact the nozzle surface 25. That is, the movement mechanism 41 moves the absorbing member 39 to the contact position Pc and the separated position Ps.

### Pressure Cleaning

The control section 12 performs pressure cleaning, for example, when a predetermined time has elapsed from the start of printing or when a predetermined time has elapsed from the previous maintenance. The control section 12 may perform pressure cleaning on the plurality of liquid ejection heads 22 collectively or one by one. Hereinafter, a description will be given of maintenance in the case where pressure cleaning of a single liquid ejection head 22 is performed.

As shown in FIG. 3, when performing maintenance, the control section 12 first moves the liquid ejection head 22 so that the nozzle surface 25 faces the impregnated section 56. At this time, the absorbing member 39 is positioned at the separated position Ps. The control section 12 drives the winding section 38 to position the unused portion in the impregnated section 56. The control section 12 may simultaneously perform movement of the liquid ejection head 22 and winding of the absorbing member 39.

As shown in FIG. 6, when the winding of the absorbing member 39 is completed, the control section 12 drives the second movement mechanism 45 to move the impregnated section 56 to the impregnation position Pi. The control section 12 causes the impregnated section 56 positioned at the impregnation position Pi to be impregnated with liquid. The control section 12 causes the impregnated section 56 to be impregnated with liquid by ejecting the liquid from the nozzle 26 to the impregnated section 56.

As shown in FIG. 7, the control section 12 drives the second movement mechanism 45 to move the impregnated section 56 to the contact position Pc. That is, the control section 12 causes the second movement mechanism 45 to bring the impregnated section 56 into contact with the nozzle surface 25. The control section 12 maintains a state in which the impregnated section 56 is brought into contact with the nozzle surface 25 for a predetermined time. The predetermined time may be several tens of seconds, one minute, or several minutes. The predetermined time may be set according to the amount of impregnating liquid, the type of impregnating liquid, the type of the absorbing member 39, the air temperature, the humidity, and the like.

As shown in FIG. 3, when a predetermined time elapses after the impregnated section 56 is brought into contact with the nozzle surface 25, the control section 12 moves the impregnated section 56 to the separated position Ps. The control section 12 separates the impregnated section 56 from the nozzle surface 25 by the second movement mechanism 45.

The control section 12 drives the winding section 38 in a state in which the absorbing member 39 is separated from the nozzle surface 25. The control section 12 moves the portion of the absorbing member 39 impregnated with the liquid from the impregnated section 56 and positions the unused portion in the wiping section 55.

The control section 12 moves the liquid ejection head 22 so that the nozzle surface 25 faces the liquid receiving section 31. The control section 12 causes the pressurizing section 23 to discharge the liquid from the liquid ejection head 22. That is, the control section 12 executes pressure cleaning. The liquid discharged from the liquid ejection head 22 is received by the liquid receiving section 31. Subsequently, the control section 12 moves the liquid ejection head 22 so that the nozzle surface 25 faces the wiping section 55.

In the state where the wiping section 55 faces the nozzle surface 25, the control section 12 drives the first movement mechanism 44 to move the wiping section 55 to the wiping position Pw. The control section 12 causes the first movement mechanism 44 to move the wiping section 55 to a position where the wiping section 55 can come into contact with the nozzle surface 25. The control section 12 uses the first movement mechanism 44 to bring the wiping section 55 into contact with the nozzle surface 25.

After moving the wiping section 55 to the wiping position Pw, the control section 12 returns the wiping section 55 to the separated position Ps. That is, the control section 12 causes the wiping section 55 to temporarily come into contact with the nozzle surface 25, and then causes the first movement mechanism 44 to separate the wiping section 55 from the nozzle surface 25. The wiping section 55 in contact with the nozzle surface 25 absorbs the liquid from pressure cleaning that clings to the nozzle surface 25.

The control section 12 drives the winding section 38 in a state in which the absorbing member 39 is separated from the nozzle surface 25. The control section 12 positions a new portion of the absorbing member 39 at the wiping section 55 by using the winding section 38 to wind the absorbing member 39.

As shown in FIG. 3, the control section 12 moves the liquid ejection head 22 in the scanning direction X1. The control section 12 moves the liquid ejection head 22 to a position not facing the wiping section 55.

As shown in FIG. 5, the control section 12 drives the first movement mechanism 44 to move the wiping section 55 to the wiping position Pw. The control section 12 causes the first movement mechanism 44 to move the wiping section 55 to a position where the wiping section 55 can come into contact with the nozzle surface 25.

The control section 12 moves the liquid ejection head 22 in the wiping direction X2. The control section 12 moves the liquid ejection head 22 to pass by the wiping section 55. The control section 12 causes the wiping section 55 to wipe the nozzle surface 25. After wiping the nozzle surface 25, the control section 12 moves the wiping section 55 to the separated position Ps.

The control section 12 moves the liquid ejection head 22 so that the nozzle surface 25 faces the liquid receiving section 31. The control section 12 causes the liquid ejection head 22 to eject liquid toward the liquid receiving section 31. That is, the control section 12 causes the wiping section 55 to wipe the nozzle surface 25, and then idly ejects liquid from the liquid ejection head 22 toward the liquid receiving section 31. By this, maintenance of a single liquid ejection head 22 is completed. The control section 12 performs maintenance on the plurality of liquid ejection heads 22 in order.

### Suction Cleaning

The control section 12 may perform suction cleaning instead of the above-described pressure cleaning for maintenance. The control section 12 may perform suction cleaning, for example, when clogging of the nozzle 26 is not recovered by pressure cleaning. The control section 12 may perform suction cleaning on the plurality of liquid ejection head 22 collectively or one by one. Hereinafter, maintenance when suction cleaning of a single liquid ejection head 22 is performed will be described.

As shown in FIG. 7, the control section 12 causes the impregnated section 56 that is impregnated with liquid to contact the nozzle surface 25 for a predetermined time in the same manner as in the case of pressure cleaning.

As shown in FIG. 3, when a predetermined time elapses after the impregnated section 56 is brought into contact with the nozzle surface 25, the control section 12 moves the impregnated section 56 to the separated position Ps and drives the winding section 38 to wind the absorbing member 39.

The control section 12 moves the liquid ejection head 22 so that the nozzle surface 25 faces the cleaning section 29. The control section 12 causes the cleaning section 29 to perform suction cleaning of the liquid ejection head 22. That is, the control section 12 causes the suction cap 35 to cap the liquid ejection head 22. The control section 12 causes the inside of the suction cap 35 to have a negative pressure to discharge the liquid from the nozzle 26. By this, the liquid is discharged from the nozzle 26. When suction cleaning is finished, control section 12 releases the capping.

Subsequently, the control section 12, as in the case of pressure cleaning, sequentially executes the operation of bringing the wiping section 55 into temporary contact with the nozzle surface 25, the operation of wiping the nozzle surface 25, and the operation of causing the liquid ejection head 22 to perform idle ejection.

Specifically, the control section 12 moves the liquid ejection head 22 so that the nozzle surface 25 faces the wiping section 55.

In the state where the wiping section 55 faces the nozzle surface 25, the control section 12 drives the first movement mechanism 44 to move the wiping section 55 to the wiping position Pw. The control section 12 uses the first movement mechanism 44 to bring the wiping section 55 into contact with the nozzle surface 25.

After moving the wiping section 55 to the wiping position Pw, the control section 12 returns the wiping section 55 to the separated position Ps. That is, the control section 12 causes the wiping section 55 to temporarily come into contact with the nozzle surface 25, and then causes the first movement mechanism 44 to separate the wiping section 55 from the nozzle surface 25. The wiping section 55 in contact with the nozzle surface 25 absorbs the liquid from suction cleaning that clings to the nozzle surface 25.

The control section 12 drives the winding section 38 in a state in which the absorbing member 39 is separated from the nozzle surface 25. The control section 12 positions a new portion of the absorbing member 39 at the wiping section 55 by using the winding section 38 to wind the absorbing member 39.

As shown in FIG. 3, the control section 12 moves the liquid ejection head 22 in the scanning direction X1. The control section 12 moves the liquid ejection head 22 to a position not facing the wiping section 55.

As shown in FIG. 5, the control section 12 drives the first movement mechanism 44 to move the wiping section 55 to the wiping position Pw. The control section 12 causes the first movement mechanism 44 to move the wiping section 55 to a position where the wiping section 55 can come into contact with the nozzle surface 25.

The control section 12 moves the liquid ejection head 22 in the wiping direction X2. The control section 12 moves the liquid ejection head 22 to pass by the wiping section 55. The control section 12 causes the wiping section 55 to wipe the nozzle surface 25. After wiping the nozzle surface 25, the control section 12 moves the wiping section 55 to the separated position Ps.

The control section 12 moves the liquid ejection head 22 so that the nozzle surface 25 faces the liquid receiving section 31. The control section 12 causes the liquid ejection head 22 to eject the liquid toward the liquid receiving section 31. That is, the control section 12 causes the wiping section 55 to wipe the nozzle surface 25, and then idly ejects liquid from the liquid ejection head 22 toward the liquid receiving section 31. By this, maintenance of a single liquid ejection head 22 is completed. The control section 12 performs maintenance on the plurality of liquid ejection heads 22 in order.

### Operation of the Present Embodiment

The operation of the present embodiment will be described.

The control section 12 causes the impregnated section 56, which is impregnated with liquid, to come into contact with the nozzle surface 25 before wiping the nozzle surface 25. The liquid clinging to the nozzle surface 25 absorbs the liquid contained in impregnated section 56, and the viscosity decreases. Therefore, the nozzle surface 25 can be easily wiped off.

When pressure cleaning and suction cleaning are performed, a part of the discharged liquid clings to nozzle surface 25. The control section 12 can reduce the liquid that clings to the nozzle surface 25 before wiping by temporarily bringing the wiping section 55 into contact with the nozzle surface 25 before wiping the nozzle surface 25. This makes it possible to increase the speed at which the wiping section 55 and the liquid ejection head 22 are moved relative to each other during wiping. Since the amount of liquid mixed into the nozzle 26 can be reduced, the amount of the liquid to be idly ejected can be reduced.

### Effects of the Present Embodiment

The effect of the present embodiment will be described.

(1-1) The absorbing member 39 includes the impregnated section 56 and the wiping section 55. The impregnated section 56 can reduce the viscosity of the liquid clinging to the nozzle surface 25 by coming into contact with the nozzle surface 25 in a state of being impregnated with liquid. Therefore, since it is possible to cause the wiping section 55 to wipe with liquid having lower viscosity, it is possible to improve the wiping property of the solidified liquid.

(1-2) The movement mechanism 41 includes a first movement mechanism 44 and a second movement mechanism 45. The first movement mechanism 44 moves the wiping section 55. The second movement mechanism 45 moves the impregnated section 56. Therefore, wiping of the nozzle surface 25 by the wiping section 55 and contact of impregnated section 56 against the nozzle surface 25 can be independently performed.

(1-3) The winding section 38 is configured to wind the absorbing member 39. When the winding section 38 winds the absorbing member 39, an unused portion of the absorbing member 39 can be used as the impregnated section 56 and the wiping section 55.

(1-4) The first movement mechanism 44 includes the roller 66. The roller 66 has elasticity. Since the roller 66 comes into contact with the back surface 54 of the wiping section 55 to sandwich the wiping section 55 between the roller 66 and the nozzle surface 25, it is possible to improve the followability of the wiping section 55 with respect to the nozzle surface 25. Therefore, wiping performance can be improved.

(1-5) The second movement mechanism 45 has a support member 75. Since the support member 75 contacts the back surface 54 of the impregnated section 56 to sandwich the contact portion between the support member 75 and the nozzle surface 25, the impregnated section 56 can be pressed against the nozzle surface 25.

(1-6) The support member 75 is movable to a position away from the impregnated section 56. Since the winding section 38 can wind the absorbing member 39 in a state where the support member 75 is separated, the load of winding can be reduced.

(1-7) The support member 75 has a porous body 78. Since the support member 75 contacts the back surface 54 of the impregnated section 56 to sandwich the impregnated section 56 between the nozzle surface 25 and the support member 75, it is possible to improve the followability of the impregnated section 56 with respect to the nozzle surface 25. Therefore, it is possible to easily reduce the viscosity of the liquid clinging to the nozzle surface 25.

(1-8) The support member 75 has an elastic body 77. Since the support member 75 contacts the back surface 54 of the impregnated section 56 to sandwich the impregnated section 56 between the nozzle surface 25 and the support member 75, it is possible to improve the followability of the impregnated section 56 with respect to the nozzle surface 25. Therefore, it is possible to easily reduce the viscosity of the liquid clinging to the nozzle surface 25.

(1-9) The liquid ejection head 22 impregnates the impregnated section 56 with the liquid ejected from the nozzle 26. Therefore, it is possible to reduce the size of the liquid ejection device 11 compared to a case where a configuration for impregnating the impregnated section 56 with the liquid is separately provided.

(1-10) After suction cleaning is performed by the cleaning section 29, the nozzle surface 25 is wiped by the wiping section 55. The distance between the wiping section 55 and the cleaning section 29 is shorter than the distance between the impregnated section 56 and the cleaning section 29. Therefore, it is possible to shorten the time required for suction cleaning and wiping.

(1-11) After suction cleaning of the liquid ejection head 22 is performed, the wiping section 55 is brought into contact with the nozzle surface 25. Therefore, it is possible to cause the wiping section 55 to absorb the liquid from suction cleaning that clings to the nozzle surface 25. The winding section 38 winds the absorbing member 39 after the wiping section 55 comes into contact with the nozzle surface 25. By winding up the absorbing member 39, an unused portion of the absorbing member 39 can be used as the wiping section 55. Therefore, the wiping section 55 can wipe the nozzle surface 25 with a new portion after reducing the liquid from suction cleaning that clings to the nozzle surface 25.

(1-12) The liquid receiving section 31 is disposed adjacent to the wiping device 30 in the scanning direction X1. For this reason, after the nozzle surface 25 is wiped by the wiping device 30, it is possible to rapidly perform idle ejection with respect to the liquid receiving section 31.

(1-13) The liquid receiving section 31 receives the liquid discharged from the liquid ejection head 22 by the pressurizing section 23. Therefore, the liquid idly ejected from the liquid ejection head 22 and the liquid discharged under pressure from the liquid ejection head 22 can be received by a single liquid receiving section 31.

(1-14) After the liquid is discharged by pressurizing the inside of the liquid ejection head 22, the wiping section 55 is brought into contact with the nozzle surface 25. Therefore, it is possible to cause the wiping section 55 to absorb the liquid from pressurized discharge that clings to the nozzle surface 25. The winding section 38 winds the absorbing member 39 after the wiping section 55 comes into contact with the nozzle surface 25. By winding up the absorbing member 39, an unused portion of the absorbing member 39 can be used as the wiping section 55. Therefore, the wiping section 55 can wipe the nozzle surface 25 with a new portion after reducing the liquid from pressurized discharge that clings to the nozzle surface 25.

### Modifications

The present embodiment can be implemented with the following modifications. The present embodiment and the following modifications can be implemented in combination with each other as long as there is no technical contradiction.

The wiping device 30 may wipe the nozzle surface 25 using the impregnated section 56. When the nozzle surface 25 is wiped, the impregnated section 56 may not be impregnated with the liquid.

The size of the support member 75 and the impregnated section 56 may be smaller than that of the nozzle surface 25. The support member 75 may press the impregnated section 56 against a part of the nozzle surface 25 multiple times while shifting position, thereby bringing the entire nozzle surface 25 into contact with the impregnated section 56.

The wiping device 30 may not temporarily bring the absorbing member 39 into contact with the nozzle surface 25 after at least one of pressure cleaning and suction cleaning. The portion of the absorbing member 39 that is temporarily brought into contact with the nozzle surface 25 after the pressure cleaning and the suction cleaning may be the impregnated section 56. The control section 12 may temporarily bring the absorbing member 39 into contact with the nozzle surface 25 after pressure cleaning and suction cleaning.

The liquid ejection device 11 may enable either pressure cleaning or suction cleaning. The liquid ejection device 11 may include either the pressurizing section 23 or the cleaning section 29.

The absorbing member 39 may receive the liquid idly ejected from the liquid ejection head 22. The absorbing member 39 may receive the liquid discharged by pressure cleaning. In this case, the liquid ejection device 11 may be configured not to include the liquid receiving section 31.

The wiping device 30 may include a transport unit that transports the strip-shaped absorbing member 39. The transporting section may collect the used absorbing member 39 so as to fold it on itself.

The printing section 14 may supply the liquid from the nozzle 26 to the impregnated section 56 by the pressurizing section 23 pressurizing the inside of the liquid ejection head 22. The pressurizing section 23 may pressurize the inside of the liquid ejection head 22 in a state in which the impregnated section 56 is in contact with the nozzle surface 25. The liquid ejection device 11 may supply the liquid to the impregnated section 56 after the nozzle surface 25 is brought into contact with the impregnated section 56.

The liquid supplied to the impregnated section 56 may be, for example, ink, a reaction liquid, water, a solvent, a moisturizing liquid, a cleaning liquid, or the like.

The wiping device 30 may include a supply section that supplies liquid to the impregnated section 56 separately from the liquid ejection head 22.

The support member 75 may be formed by stacking the porous body 78 and the elastic body 77 in this order on the support plate 76.

The support member 75 may be configured not to include at least one of the porous body 78 and the elastic body 77.

The second movement mechanism 45 may be configured not to include the support member 75. The first movement mechanism 44 may move the impregnated section 56, for example, by moving the guide roller 40.

The movement mechanism 41 may move the impregnated section 56 to the contact position Pc by the first movement mechanism 44.

The roller 66 may be rigid.

The first movement mechanism 44 may be configured not to include the roller 66. The first movement mechanism 44 may press the wiping section 55 against the nozzle surface 25 with, for example, a plate-shaped member.

The wiping device 30 may be provided separately from the liquid ejection device 11.

The liquid ejection device 11 may be a liquid ejection device that sprays or ejects liquid other than ink. The state of the liquid which is ejected from the liquid ejection device in the form of a minute amount of liquid droplets includes granular, tear-shaped, and shapes with a thread-like tail. Here, the liquid may be a material that can be ejected from the liquid ejection device. For example, the liquid may be in a state where a substance is in a liquid phase and includes a fluid body such as a liquid body having high or low viscosity, sol, gel water, other inorganic solvents, an organic solvent, a solution, a liquid resin, and a liquid metal (metal melt). The liquid includes not only a liquid as one state of a substance but also a liquid in which particles of a functional material made of a solid material such as a pigment or metal particles are dissolved, dispersed, or mixed in a solvent. Typical examples of the liquid include liquid crystal and ink as described in the above embodiment. Here, the ink includes various liquid compositions such as general water-based ink, oil-based ink, gel ink, and hot-melt ink. As a specific example of the liquid ejection device, there is a device that ejects a liquid containing a material in a dispersed or dissolved form such as an electrode material or a color material used for manufacturing a liquid crystal display, an electroluminescence display, a surface emitting display, a color filter, or the like. The liquid ejection device may be a device for ejecting a bioorganic substance used for manufacturing a biochip, a device for ejecting a liquid to be a sample used as a precision pipette, a printing device, a microdispenser, or the like. The liquid ejection device may be a device that ejects lubricating oil in a pinpoint manner to precision machinery such as watches or cameras, or a device that ejects a transparent resin liquid such as an ultraviolet curable resin onto a substrate to form micro hemispherical lenses, optical lenses, or the like used in optical communication elements or similar applications. The liquid ejection device may be a device for ejecting an etching solution such as an acid or an alkali for etching a substrate or the like.

### Definitions

As used herein, the expression “at least one” means “one or more” of the desired options. As an example, the expression “at least one” as used herein means “only one option” or “both of the two options” when the number of options is two. As another example, the expression “at least one” as used herein means “only one option”, “a combination of two optional options”, or “a combination of three or more optional options” when the number of options is three or more.

### NOTES

Hereinafter, technical ideas grasped from the above-described embodiment and modifications, and operations and effects thereof will be described.

(A) A wiping device configured to wipe a nozzle surface of a liquid ejection head that ejects liquid, the wiping device including a band-shaped absorbing member configured to absorb the liquid and a movement mechanism that moves the absorbing member to a contact position where the absorbing member is contactable with the nozzle surface and a separated position at which the absorbing member is separated from the nozzle surface, wherein the absorbing member includes an impregnated section configured to contact the nozzle surface in a state of being impregnated with liquid and a wiping section configured to wipe the nozzle surface by moving relative to the liquid ejection head.

According to this configuration, the absorbing member includes an impregnated section and a wiping section. The impregnated section can reduce the viscosity of the liquid clinging to the nozzle surface by coming into contact with the nozzle surface in a state of being impregnated with the liquid.

Therefore, since it is possible to cause the wiping section to wipe using the liquid with reduced viscosity, it is possible to improve the wiping property against solidified liquid.

(B) The wiping device as according to (A), wherein
the movement mechanism includes a first movement mechanism configured to move the wiping section of the absorbing member to a position where the wiping section is contactable with the nozzle surface and a second movement mechanism configured to move the impregnated section of the absorbing member to a position where the impregnated section contacts the nozzle surface.

According to this configuration, the movement mechanism is provided with a first movement mechanism and a second movement mechanism. The first movement mechanism moves the wiping section. The second movement mechanism moves the impregnated section. Therefore, the wiping of the nozzle surface by the wiping section and the contact of the impregnated section to the nozzle surface can be independently performed.

(C) The wiping device according to (A) or (B), wherein the wiping device further includes a winding section configured to wind the absorbing member.

According to this configuration, the winding section is configured to wind the absorbing member. When the winding section winds up the absorbing member, the unused portion of the absorbing member can be used as the impregnated section and the wiping section.

(D) The wiping device according to (B) or (C), wherein the first movement mechanism includes a roller that comes into contact with a back surface of the wiping section, the back surface being at an opposite side of a contact surface that comes into contact with the nozzle surface and the roller has an elastic portion that comes into contact with the wiping section.

According to this configuration, the first movement mechanism has a roller. The roller has elasticity. Since the roller comes into contact with the back surface of the wiping section to sandwich the wiping section between the roller and the nozzle surface, it is possible to improve the followability of the wiping section with respect to the nozzle surface. Therefore, wiping performance can be improved.

(E) The wiping device according to (B) to (D), wherein the second movement mechanism includes a support member that comes into contact with a back surface of the impregnated section, the back surface being at an opposite side of a contact surface that comes into contact with the nozzle surface.

According to this configuration, the second movement mechanism includes a support member. Since the support member contacts the back surface of the impregnated section to sandwich the contact portion between the support member and the nozzle surface, the impregnated section can be pressed against the nozzle surface.

(F) The wiping device according to (E) wherein the second movement mechanism is movable between a position at which the support member is brought into contact with the impregnated section and a position at which the support member is separated from the impregnated section.

According to this configuration, the support member is movable to a position away from the impregnated section. Since the winding section can wind up the absorbing member in a state where the support member is separated, the load of winding can be reduced.

(G) The wiping device according to (E) or (F), wherein the support member has a porous body.

According to this configuration, the support member has a porous body. Since the support member contacts the back surface of the impregnated section to sandwich the impregnated section between the nozzle surface and the support member, it is possible to improve the followability of the impregnated section with respect to the nozzle surface. Therefore, it is possible to easily reduce the viscosity of the liquid attached to the nozzle surface.

(H) The wiping device according to (E) to (G), wherein the support member has an elastic body.

According to this configuration, the support member has an elastic body. Since the support member contacts the back surface of the impregnated section to sandwich the impregnated section between the nozzle surface and the support member, it is possible to improve the followability of the impregnated section with respect to the nozzle surface. Therefore, it is possible to easily reduce the viscosity of the liquid attached to the nozzle surface.

(I) The liquid ejection device includes a liquid ejection head for ejecting a liquid from a nozzle formed in the nozzle surface, and a wiping device described in (A) to (H). According to this configuration, the same effect as that of the wiping device can be obtained.

(J) The control method of the liquid ejection device including a liquid ejection head that ejects a liquid from a nozzle formed in a nozzle surface and a wiping device configured to wipe the nozzle surface, wherein the wiping device includes an absorbing member having a wiping section configured to wipe the nozzle surface by moving relative to the liquid ejection head, and an impregnated section configured to come into contact with the nozzle surface in a state of being impregnated with a liquid and a movement mechanism that has a first movement mechanism configured to move the wiping section of the absorbing member to a position where the wiping section is contactable with the nozzle surface, and a second movement mechanism configured to move the impregnated section of the absorbing member to a position where the impregnated section contacts the nozzle surface, the control method including using the second movement mechanism to bring the impregnated section into contact with the nozzle surface, and maintaining a state in which the impregnated section contacts the nozzle surface for a predetermined time, using the second movement mechanism to separate the impregnated section from the nozzle surface, using the first movement mechanism to move the wiping section to a position where the wiping section is contactable with the nozzle surface, and wiping the nozzle surface with the wiping section.

According to this method, the same effect as that of the wiping device can be obtained.

(K) The control method of a liquid ejection device according to (J) further including impregnating the impregnated section with a liquid by ejecting the liquid from the nozzle to the impregnated section.

According to this method, the liquid ejection head impregnates the impregnated section with the liquid ejected from the nozzle. Therefore, it is possible to reduce the size of the liquid ejection device compared to a case where a configuration for impregnating the impregnated section with the liquid is separately provided.

(L) The control method of a liquid ejection device according to (J), or (K), the liquid ejection device further including a cleaning section that suctions liquid from the liquid ejection head to perform suction cleaning of the liquid ejection head, wherein the liquid ejection head is movable in the scanning direction and the wiping section is disposed between the cleaning section and the impregnated section in the scanning direction, the control method further including performing suction cleaning of the liquid ejection head by the cleaning section, using the first movement mechanism to move the wiping section to a position where the wiping section is contactable with the nozzle surface, and wiping the nozzle surface with the wiping section.

According to this method, after suction cleaning is performed by the cleaning section, the nozzle surface is wiped by the wiping section. The distance between the wiping section and the cleaning section is shorter than the distance between the impregnated section and the cleaning section. Therefore, it is possible to shorten the time required for suction cleaning and wiping.

(M) The control method of the liquid ejection device according to (L), the wiping device further including a winding section configured to wind the absorbing member, the control method further including performing suction cleaning of the liquid ejection head by the cleaning section, using the first movement mechanism to bring the wiping section into contact with the nozzle surface, using the first movement mechanism to separate the wiping section from the nozzle surface, positioning a new portion of the absorbing member in the wiping section by using the winding section to wind the absorbing member, and using the first movement mechanism to move the wiping section to a position where the wiping section is contactable with the nozzle surface.

According to this method, after performing suction cleaning of the liquid ejection head, the wiping section is brought into contact with the nozzle surface. Therefore, it is possible for the wiping section to absorb the liquid from suction cleaning that clings to the nozzle surface. The winding section winds the absorbing member after the wiping section comes into contact with the nozzle surface. By winding the absorbing member, an unused portion of the absorbing member can be used as a wiping section. Therefore, the wiping section can wipe the nozzle surface with a new portion after reducing the liquid from suction cleaning that clings to the nozzle surface.

(N) The control method of the liquid ejection device according to (J) to (M), the liquid ejection device further including a liquid receiving section that receives liquid idly ejected from the liquid ejection head, wherein in the scanning direction, the liquid receiving section is disposed adjacent to the wiping device, the control method further including after wiping the nozzle surface by the wiping section, the liquid is idly ejected from the liquid ejection head toward the liquid receiving section.

According to this method, the liquid receiving section is disposed adjacent to the wiping device in the scanning direction. For this reason, after the nozzle surface is wiped by the wiping device, it is possible to rapidly perform idle ejection with respect to the liquid receiving section.

(O) The control method of the liquid ejection device according to (N), the liquid ejection device further including a pressurizing section configured to pressurize the inside of the liquid ejection head to discharge liquid from the liquid ejection head, the control method further including receiving in the liquid receiving section, the liquid that was discharged from the liquid ejection head by the pressurizing section, using the first movement mechanism to move the wiping section to a position where the wiping section is contactable with the nozzle surface, and wiping the nozzle surface with the wiping section.

According to this method, the liquid receiving section receives the liquid discharged from the liquid ejection head by the pressurizing section. Therefore, the liquid idly ejected from the liquid ejection head and the liquid ejected under pressure from the liquid ejection head can be received in a single liquid receiving section.

(P) The control method of a liquid ejection device according to (O), the wiping device further including a winding section configured to wind the absorbing member, the control method further including discharging liquid from the liquid ejection head by the pressurizing section, using the first movement mechanism to bring the wiping section into contact with the nozzle surface, using the first movement mechanism to separate the wiping section from the nozzle surface, positioning a new portion of the absorbing member in the wiping section by using the winding section to wind the absorbing member, and using the first movement mechanism to move the wiping section to a position where the wiping section is contactable with the nozzle surface.

According to this method, after pressurizing the inside of the liquid ejection head to discharge the liquid, the wiping section is brought into contact with the nozzle surface. Therefore, it is possible to cause the wiping section to absorb the liquid from pressurized discharge that clings to the nozzle surface. The winding section winds the absorbing member after the wiping section comes into contact with the nozzle surface. By winding the absorbing member, an unused portion of the absorbing member can be used as a wiping section. Therefore, the wiping section can wipe the nozzle surface with a new portion after reducing the liquid form pressurized discharge that clings to the nozzle surface.

What is claimed is:

1. A wiping device configured to wipe a nozzle surface of a liquid ejection head that ejects liquid, the wiping device comprising:
a band-shaped absorbing member configured to absorb the liquid and
a movement mechanism that moves the absorbing member to a contact position where the absorbing member is contactable with the nozzle surface and a separated position at which the absorbing member is separated from the nozzle surface, wherein
the absorbing member includes
an impregnated section configured to contact the nozzle surface in a state of being impregnated with liquid and
a wiping section configured to wipe the nozzle surface by moving relative to the liquid ejection head.

2. The wiping device according to claim 1, wherein
the movement mechanism includes
a first movement mechanism configured to move the wiping section of the absorbing member to a position where the wiping section is contactable with the nozzle surface and
a second movement mechanism configured to move the impregnated section of the absorbing member to a position where the impregnated section contacts the nozzle surface.

3. The wiping device according to claim 2, further comprising:
a winding section configured to wind the absorbing member.

4. The wiping device according to claim 3, wherein
the first movement mechanism includes a roller that comes into contact with a back surface of the wiping section, the back surface being at an opposite side of a contact surface that comes into contact with the nozzle surface and
the roller has an elastic portion that comes into contact with the wiping section.

5. The wiping device according to claim 3, wherein
the second movement mechanism includes a support member that comes into contact with a back surface of the impregnated section, the back surface being at an opposite side of a contact surface that comes into contact with the nozzle surface.

6. The wiping device according to claim 5, wherein
the second movement mechanism is movable between a position at which the support member is brought into contact with the impregnated section and a position at which the support member is separated from the impregnated section.

7. The wiping device according to claim 6, wherein
the support member has a porous body.

8. The wiping device according to claim 6, wherein
the support member has an elastic body.

9. A liquid ejection device comprising:
a liquid ejection head that ejects a liquid from a nozzle formed in a nozzle surface and
the wiping device according to claim 1.

10. A control method of a liquid ejection device, the liquid ejection device including
a liquid ejection head that ejects a liquid from a nozzle formed in a nozzle surface and
a wiping device configured to wipe the nozzle surface, wherein
the wiping device includes
a wiping section configured to wipe the nozzle surface by moving relative to the liquid ejection head,
an absorbing member including an impregnated section configured to come into contact with the nozzle surface in a state of being impregnated with a liquid, and
a movement mechanism that has a first movement mechanism configured to move the wiping section of the absorbing member to a position where the wiping section is contactable with the nozzle surface, and
a second movement mechanism configured to move the impregnated section of the absorbing member to a position where the impregnated section contacts the nozzle surface,
the control method comprising:
using the second movement mechanism to bring the impregnated section into contact with the nozzle surface, and maintaining a state in which the impregnated section contacts the nozzle surface for a predetermined time;
using the second movement mechanism to separate the impregnated section from the nozzle surface;
using the first movement mechanism to move the wiping section to a position where the wiping section is contactable with the nozzle surface; and
wiping the nozzle surface with the wiping section.

11. The control method of a liquid ejection device according to claim 10, further comprising:
impregnating the impregnated section with a liquid by ejecting the liquid from the nozzle to the impregnated section.

12. The control method of a liquid ejection device according to claim 10, the liquid ejection device further including
a cleaning section that suctions liquid from the liquid ejection head to perform suction cleaning of the liquid ejection head, wherein
the liquid ejection head is movable in the scanning direction and
the wiping section is disposed between the cleaning section and the impregnated section in the scanning direction,
the control method further comprising:
performing suction cleaning of the liquid ejection head by the cleaning section;
using the first movement mechanism to move the wiping section to a position where the wiping section is contactable with the nozzle surface; and
wiping the nozzle surface with the wiping section.

13. The control method of a liquid ejection device according to claim 12, the wiping device further including
a winding section configured to wind the absorbing member,
the control method further comprising:
performing suction cleaning of the liquid ejection head by the cleaning section;
using the first movement mechanism to bring the wiping section into contact with the nozzle surface;
using the first movement mechanism to separate the wiping section from the nozzle surface;
positioning a new portion of the absorbing member in the wiping section by using the winding section to wind the absorbing member; and
using the first movement mechanism to move the wiping section to a position where the wiping section is contactable with the nozzle surface.

14. The control method of a liquid ejection device according to claim 12, the liquid ejection device further including
a liquid receiving section that receives liquid idly ejected from the liquid ejection head, wherein
in the scanning direction, the liquid receiving section is disposed adjacent to the wiping device,
the control method further comprising:
after wiping the nozzle surface by the wiping section, the liquid is idly ejected from the liquid ejection head toward the liquid receiving section.

15. The control method of a liquid ejection device according to claim 14, the liquid ejection device further including
a pressurizing section configured to pressurize the inside of the liquid ejection head to eject liquid from the liquid ejection head,
the control method further comprising:
receiving in the liquid receiving section, the liquid that was ejected from the liquid ejection head by the pressurizing section;
using the first movement mechanism to move the wiping section to a position where the wiping section is contactable with the nozzle surface; and
wiping the nozzle surface with the wiping section.

16. The control method of a liquid ejection device according to claim 15, the wiping device further including
a winding section configured to wind the absorbing member,
the control method further comprising:
discharging liquid from the liquid ejection head by the pressurizing section;
using the first movement mechanism to bring the wiping section into contact with the nozzle surface;
using the first movement mechanism to separate the wiping section from the nozzle surface;
positioning a new portion of the absorbing member in the wiping section by using the winding section to wind the absorbing member; and
using the first movement mechanism to move the wiping section to a position where the wiping section is contactable with the nozzle surface.
